(19) United States
(12) Patent Application Publication
(10) Pub. No.: US 2020/0015627 A1
(43) Pub. Date: Jan. 16, 2020

(54) FIRE CUBE TYPE OF AN IGNITING CONTAINER

(71) Applicant: Seung-Wha YOO, Seongnam-si (KR)

(72) Inventor: Seung-Wha YOO, Seongnam-si (KR)

(21) Appl. No.: 16/032,500

(22) Filed: Jul. 11, 2018

(51) Int. Cl. A47J 37/07

(52) U.S. Cl. CPC A47J 37/079; F23Q 13/04

(57) ABSTRACT

Provided is a fire cube type of an igniting container, in particular the igniting container which is ignited itself for burning a charcoal contained therein. The fire cube type of an igniting container, includes a receiving volume formed by at least one wall, and made for an inflammable material; a flowing exit formed at an upper part of the receiving volume; a first and second opening formed at opposite parts of the at least one wall; an ignition guiding module forming a plural of flowing tubes to connect the flowing exit, the first and second opening, and displaced within the receiving volume, wherein an ignition is initiated at a position where the plural of flowing tubes intersect.

### BACKGROUND OF THE INVENTION

### 1. Field of the Invention

The present invention relates to a fire cube type of an igniting container, in particular the igniting container which is ignited itself for burning a charcoal contained therein.

### 2. Description of the Related Art

A charcoal means a solid product produced by burning a wood in a condition of being no air or little air. The charcoal may be utilized for cooking or heating, in particular may be utilized for roasting various meats or fishes to keep peculiar taste. An ignitor such as an alcohol, a paper or an active carbon that is burnt easily may be utilized for igniting the charcoal. But such ignitor may be prepared separately and a process for igniting the charcoal from the ignitor may be troublesome. Therefore, a method for igniting the charcoal easily need to be developed.

KR patent registration no. 10-1083337 describes an apparatus for igniting a charcoal comprising a first cooling module having a first flowing hole; a second cooling module to be coupled to the first cooling module; and a burner for making a frame. And KR patent publishing no. 10-2014-0066077 describes a charcoal roasting device comprising an electrical heater having a rod shape; a ring type of an air regulating container surrounding the electrical heater; and a charcoal container placed at the air regulating container. But the known device have disadvantage that is complex and it is difficult to handle.

### Purpose of the Invention

The purpose of the present invention is to provide with a fire cube type of an igniting container which makes an ignition and a framing of the charcoal easily, have a portable and an easy moving property and is utilized regardless of places, at the same time have an eco-friendly property.

### SUMMARY OF THE INVENTION

In one embodiment of the present invention, a fire cube type of an igniting container comprises a receiving volume formed by at least one wall, and made for an inflammable material; a flowing exit formed at an upper part of the receiving volume; a first and second opening formed at opposite parts of the at least one wall; an ignition guiding module forming a plural of flowing tubes to connect the flowing exit, the first and second opening, and displaced within the receiving volume, wherein an ignition is initiated at a position where the plural of flowing tubes intersect.

In other embodiment of the present invention, a bottom surface of the receiving volume is coupled to the at least one wall with at least one protruding tab formed at a periphery of the bottom surface.

In another embodiment of the present invention, the plural of flowing tubes comprise a first and a second flowing tube extending in opposite direction and have different section sizes.

In still another embodiment of the present invention, a passage center of the second flowing tube is located below that of the first flowing tube.

### BRIEF DESCRIPTION OF THE DRAWINGS

The above and other aspects, features and advantages of certain exemplary embodiments of the present invention will be more apparent from the following detailed description taken in conjunction with the accompanying drawings, in which:

FIG. 1 shows an example of a fire cube type of an igniting container according to an embodiment of the present invention.

FIG. 2 shows an example of an inner structure of the igniting container to an embodiment of the present invention.

FIG. 3 shows an example of an ignition guiding module according to an embodiment of the present invention.

FIGS. 4a and 4b shows an example of the ignition guiding module connected to each other according to an embodiment of the present invention.

FIG. 5 shows an example using the igniting container according to an embodiment of the present invention.

### DETAILED DESCRIPTION OF EXEMPLARY EMBODIMENTS

Exemplary embodiments of the present invention will be described herein below with reference to the accompanying drawings.

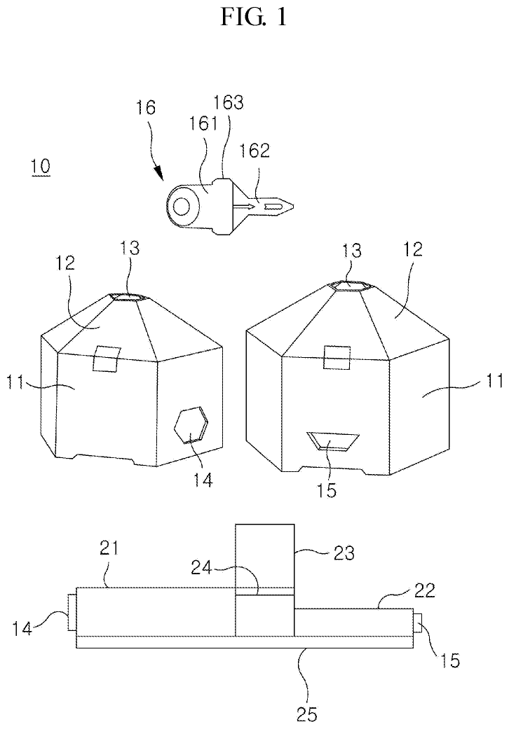

FIG. 1 shows an example of a fire cube type of an igniting container 10 according to an embodiment of the present invention.

Referring to FIG. 1, a fire cube type of an igniting container 10 may comprise a receiving volume formed by at least one wall 11, and made for an inflammable material; a flowing exit 13 formed at an upper part of the receiving volume; a first and second opening 14, 15 formed at opposite parts of the at least one wall 11; and an ignition guiding module 20 forming a plural of flowing tubes 21, 22, 23 to connect the flowing exit, the first and second opening, and displaced within the receiving volume, wherein an ignition is initiated at a position where the plural of flowing tubes intersect.

An inflammable material such as a charcoal or the like may be received within the container 10, and the container 10 may initiate a combustion of the inflammable material to burn the material at various spots at the same time. The inflammable material such as the charcoal may be received within the receiving volume having an enclosed structure to be formed by the at least one wall 11. The igniting container 10 may have a shape of a circular cylinder, an elliptic cylinder, a polyprism, a combination thereof or the like. The igniting container 10 have the enclosed structure in general, preferably a shape in which a body becomes a trigonal, a cubic or the like and a roof extending from each edge becomes a shape of a pyramid. The ignition guiding module 20 may be placed within the receiving volume, and the ignition guiding module 20 may be surrounded by the inflammable material such as the charcoal or a hardwood charcoal to fill the receiving volume. The ignition guiding module 20 may have a portable property for example being carried with a hand, with a car or any other moving means. A wrapper for the container 10 may be opened to locate the container 10 in a roasting apparatus for a barbecue, meat, fish or the like, and then a flame may be applied in a igniting key 16 to start inflame the ignition guiding module 20. As the ignition guiding module 20 is burned, the inflammable material can start being burned. The container 10 itself can be made from an inflammable material, therefore there remains only some ash after roasting.

The receiving volume can be formed by the plural of walls 11, for example, a cubic, a hexagonal or an octagonal shape of the receiving volume may be formed by four, six or eight walls 11. A bottom surface 25 may be coupled to the lower edges of the plural of walls 11, and a roof can be made by a plural of top surfaces 12 extending from the plural of the walls 11 in a single body. Alternatively a cylindrical shape of the receiving volume may be formed by one wall 11 to make a cone shape of the roof by one top surface 12. The roof may have a shape of a pyramid or a cone in general, and a circle shape of a flowing exit 13 may be formed in a peak of the roof. The flowing exit 13 may become an opening to input the igniting within the receiving volume and an exiting passage to flow a smoke or any other materials generated during the combustion of the ignition guiding module or some charcoal. The flowing exit 13 may be formed each end part of the top surface 12. Specifically each top surface 12 may extend from each upper edge of the wall 11 in angled direction, and each end part of top surface 12 extend to a length not to meet each other, while each side part of top surface 12 is adhered each other. Therefore, a top view of the flowing exit 13 may have the same shape as that of the bottom surface 25 or the receiving volume with different sizes each other.

A first flowing opening 14 may be formed at one wall 11, and a second flowing opening 15 may be formed at other wall 11 formed in an opposite to the one wall 11. Preferably the first flowing opening 14 may face to the second flowing opening 15 along a straight line. A structure of the first flowing opening 14 may be the same that of the first flowing opening 14 or different from that of the second flowing opening 15, and the first and second flowing opening 14, 15 may be connected to the flowing exit 13 by a first, a second and a third flowing tube 21, 22, 23. Specifically an outside air introduced within the receiving volume through the first and second flowing opening 14, 15 may flow along the first and second flowing tube 21, 22, and then the air may flow along the third tube 23 at an igniting plate 24. At the same time the smoke or any other materials generated during combustion can flow along the third tube 23 to exit from the receiving volume together the air. In the course of the air flow, an oxygen required for burning the inflammable material surrounding the igniting module 20 may be supplied through the first and second opening 14, 15. The first and second flowing opening 14, 15 may be interconnected by the third tube 23. The plural of flowing openings 14, 15 may be formed in various locations, for example some flowing openings not to be connected by the first and the second flowing tube 21, 23 may be formed at various places of the walls 11.

The container 10 may be made from an inflammable material in general, for example made from a paper, a sawdust, a pulp or the like. The inflammable material may start burning easily. And also, the igniting container 10 may be made from an eco-friendly material that can maintain burning for a while and generates no harmful substance to an environment during combustion. The ignition guiding module 20 displaced with the receiving volume can have a function to keep the burning state for a while. And the inflammable material such as the charcoal can burn by itself during the combustion of the ignition guiding module 20. An ignition within the container 10 can be initiated by the igniting plate 24 to be located within the receiving volume. Specifically the igniting plate 24 may be placed at the position where the first, the second and the third flowing tube 21, 22, 23 intersect. And the ignition of the igniting plate 24 may be initiated by the igniting key 16 to be located within the receiving volume.

The igniting key 16 may become a shape of a plate in general, and may comprise a handle 161 extending with a large size relatively and a igniting part 162 extending from the handle 161, wherein the igniting part 162 extends with a constant width after becoming smaller along extending direction, and then the igniting part 162 may form a sharp end. And also, fixing protrusions 163 bent in different directions may formed at both edges of the handle 161. The igniting plate 16 may be made from a material similar to that of the walls 11 or the top surfaces 12. According to an embodiment of the present invention, an oil coating layer may be formed on the igniting part 162. The oil may have an igniting property, and a linear shape of a hall may be formed along a middle part of the igniting part 162 to be burned easily.

When the container 10 is not used, the igniting key 16 may be inserted into an upper part of the flowing exit 13 to be coupled to inner surfaces by the fixing protrusions 163. The igniting key 16 may be removed from the flowing exit 13 for using the container 10. And then the igniting key 16 may be ignited to be input within the receiving volume through the flowing exit 13. The igniting key 16 may drop down along the flowing exit 13 to reach the igniting plate 24 for igniting. The ignition guiding module 20 may begin to burn with the igniting plate 24 burned, and then the charcoal filled within the receiving volume may be burned. It is necessary for the burning of the ignition guiding module 20 to be kept for several seconds, and then the charcoal may be burned by itself. The air can be introduced within the container for burning the charcoal.

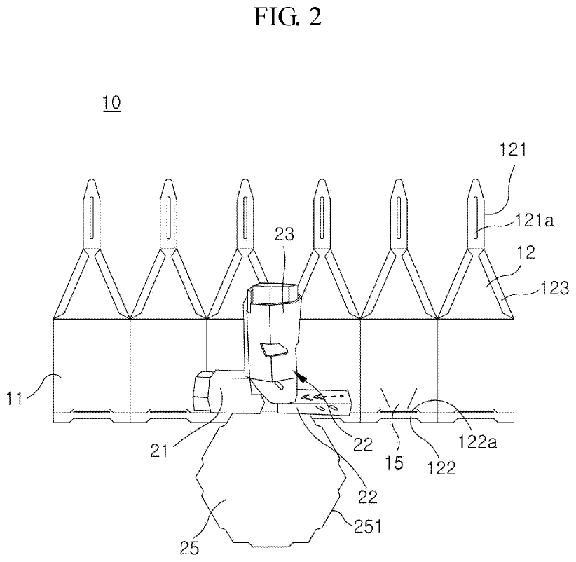

FIG. 2 shows an example of an inner structure of the igniting container to an embodiment of the present invention.

Referring to FIG. 2, the bottom surface 25 of the receiving volume is coupled to the at least one wall with at least one protruding tab 251 formed at a periphery of the bottom surface 25.

Each wall 11 may become a rectangular shape to share an adjacent side for connecting, and each top surface 12 may extend from an upper edge in a triangle shape to form a folding wings 121 by making an end part be a triangle shape. The folding parts 123 may be formed along both of edges of each top surface 12 to couple adjacent top surfaces 12 by adhering. The folding wings 121 may be folded inwardly to be adhered, and a fixing hole 121a may be formed along the extending direction of the folding wings 121. The fixing protrusions of the igniting key may be hung at the fixing hole 121a, and the igniting key may be coupled to the third flowing tube.

The bottom surface 25 may have a hexagonal shape in general, and the protruding tabs 251 may be formed a portion of the edge of the bottom surface 25. The shape of the bottom surface 25 may be fitted to that of the receiving volume, and the bottom surface 25 may have a rectangular shape if the receiving volume has a cubic shape. The protruding tabs 251 may be coupled to a coupling grooves 122a formed at an adding wings 122 wherein the coupling grooves 122a may be formed at each wall 11. Specifically a lower part of each wall 11 may have a double folded structure, and the adding wings 122 may be formed at a folded surface. And the coupling grooves 122a for coupling the protruding tabs 251 may be formed at the adding wings 122. The coupling grooves 122a may be located above an end part of the walls 11 to make the bottom surface 25 apart from the ground. Such structure of the bottom surface 25 may prevent a humidity of the ground from being permeated to make an air flowing volume be formed between the ground and the bottom surface 25. The ignition guiding module 20 have a shape of a reverse-T in general, and a portion of the ignition guiding module 20 may be coupled to the wall 11.

The second flowing tube 22 may have a different structure from that of the first flowing tube 21. The second flowing tube 22 may have a rectangular cross sectional shape, while the first flowing tube 21 may have a hexagonal cross sectional shape. The second flowing opening 15 may have an upper edge longer than a lower edge, and the second flowing tube 22 may be connected to the second flowing opening 15, as the first flowing tube 21 may be connected to the first flowing opening 14 with the hexagonal cross sectional shape. According to one embodiment of the present invention, the center of the flowing path within the second flowing tube 22 may be positioned below that of the first flowing tube 21. For example, the first flowing tube 21 may extend with the hexagonal cross section, while the second flowing tube may extend with the rectangular cross section, wherein the rectangular cross section may correspond to a lower half of the hexagonal cross section and the rectangular cross section may be a trapezoid cross section actually. The above mentioned structure of the first and second flowing tube 21, 22 may have an advantage that each air introduced to the first and second opening 14, 15 can flow to the third flowing tube 23 through the first and second flowing tube 21, 22, respectively without counter-action. The first or second flowing tube 21 or 22 may have various structure, therefore the present invention is not limited to the above-mentioned example.

Each flowing tube 21, 22, 23 may have a double-folded surrounding surface. And at least one penetrating hole may be formed at the flowing path for exiting some air or smoke. The ignition guiding module 20 may be made as a three dimensional shape from a two dimensional development. And so does the receiving volume.

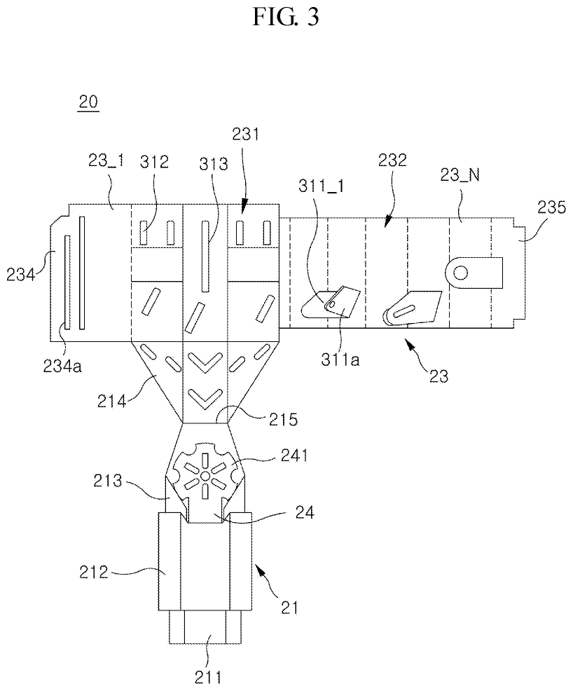

FIG. 3 shows an example of an ignition guiding module 20 according to an embodiment of the present invention.

In an embodiment of the ignition guiding module 20 illustrated in FIG. 3, the first flowing tube 21 will be illustrated as a sectional view, and the third flowing tube 23 will be illustrated as a development in two dimensional shape. Even though the second flowing tube may be not depicted, it should be understood that the second flowing tube may extend in the opposite of the first flowing tube. The first or second flowing tube 21 or 22 may be made as a method similar to that for producing the third flowing tube 23, hence the method for producing the first or second flowing tube 21 or 22 will be not described below.

Referring to FIG. 3, a plural of tube wall units 23_1 to 23_N may be connected to each other, and each tube wall unit 23_1 to 23_N may have an identical or a different shape each other. Specifically each tube wall unit 23_1 to 23_N forming the third flowing tube may have a rectangular shape, wherein each tube wall unit 23_1 to 23_F forming an inner flowing tube 231 may have a different size from that of each tube wall unit 23_K to 23_N forming an outer flowing tube 232. And also, a number of the tube wall units 23_1 to 23_F forming the inner flowing tube 231 may be identical to or different from that of the tube wall units 23_K to 23_N forming the outer flowing tube 232. A receiving wing 234 having a receiving groove 234a and a coupling wing 234 having a coupling tab 235a may be formed at a first tube wall unit 23_1 and a Nth tube wall unit 23_N, respectively. And various type of guiding holes 312, 313 may be formed on at least one tube wall unit 23_1 to 23_N. And also, a plural of supporting tabs 311a_1 to 311a_K may be formed the at least one tube wall unit 23_K to 23_N forming the outer flowing tube 232. Each supporting tab 311a_1 to 311a_K may be formed in a manner that a polygon is made at an inner surface of the at least one tube wall unit 23_K to 23_N and then all of the edges except one edge is removed by cutting. Hence, the supporting tabs 311a1 to 311a_K may be not separated from the tube wall units 23_K to 23_N, and a penetrating hole 311_1 may be formed at the cut part. Each supporting tab 311a_1 to 311a_K may be coupled to the guiding holes 312, 323 formed at the inner tube wall units 23_1 to 23_F in the course of assembling. And a gap may be formed between the inner flowing tube 231 and the outer flowing tube 232 because of the above-mentioned structure to make the third flowing tube 23 have an improved stability.

The first flowing tube 21 or the second flowing tube 22 may be made a similar way to produce the third flowing tube 23, and the first and second flowing tube 22, 23 may be connected to the third tube 23 extending in the opposite direction, respectively. Specifically the first flowing tube 21 may comprise a connecting-flowing tube 211 and an outer protecting tube 212 surrounding the connecting-flowing tube 211. A one end of the connecting-flowing tube 211 may be connected to the first flowing opening described above, while an other end of the connecting-flowing tube 211 may be connected to the third flowing tube 23. The igniting plate 24 may be connected to an upper surface of the connecting-flowing tube 211, and a first extending part 213 may be formed at a side surface of the connecting-flowing tube. And a second extending part 214 may be formed at the outer flowing tube 231 of the third flowing tube 23 to extend to the first extending part 213 for connecting. The first flowing tube 21 may be connected to the third flowing tube 23 by the first extending part 213 and the second extending part 214. And the second flowing tube 22 may be connected to the third flowing tube 23 in a similar way.

The igniting plate 24 may become a bottom part of the third flowing tube 23, and have a circular shape in general with a plural of protrusions along the circumference. And also, a plural of guiding-penetrating holes 241 may be formed in an inner part of the igniting plate 24. Some air introduced from the first flowing tube 21 or the second flowing tube 22 may flow to the third flowing tube 23 through a gap formed between the protrusions or the plural of guiding-penetrating holes 241.

The igniting plate 24 may have various structures, not limited to the above example.

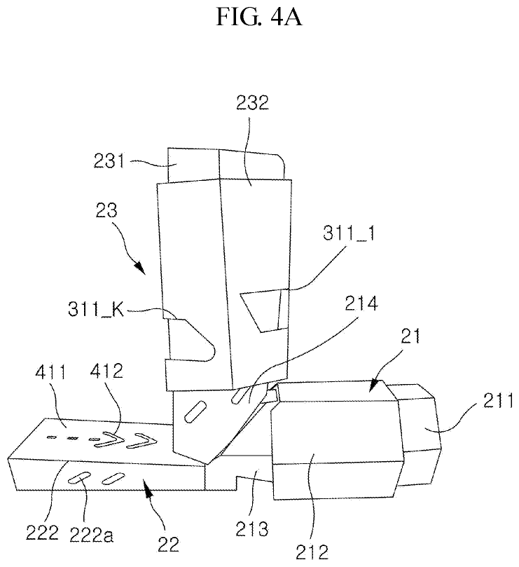

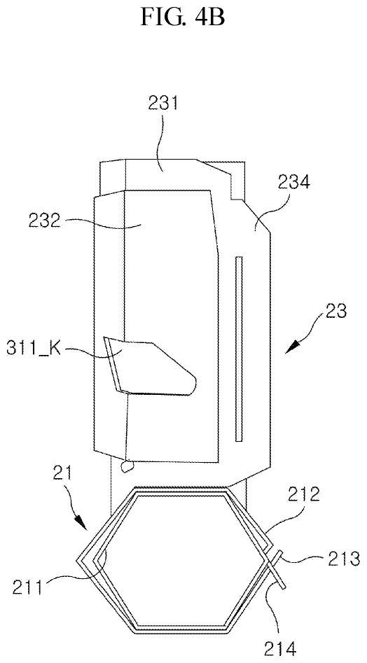

FIGS. 4a and 4b shows an example of the ignition guiding module connected to each other according to an embodiment of the present invention.

Referring to FIGS. 4a and 4b, the first and second flowing tube 21, 22 may extend in a straight line, respectively, and the third flowing tube 23 may extend in a perpendicular direction to the straight line. And also, the first extending part 213 and second part 214 may be formed as a tilted-contacting line AL to make each entering section of the first and second flowing tube 21, 22 have a different size each other. The first and the third flowing tube 21, 23 may become a double walled structure, and the second flowing tube 22 may become a single passage structure. At the same time, an upper surface of the second flowing tube 22 have a plane with a relatively larger size. And also, a plural of discharging holes 411, 412, 222a may be formed at the upper surface or a side surface of the second flowing tube 22 along a flowing direction. Hence, the outer air introduced to the second flowing tube 22 may be supplied to the inflammable material filled within the receiving volume through the discharging holes 411, 412, 222a. And also, the air introduced to the first flowing tube 21 may flow to the third flowing tube 23. A plural of penetrating holes 311_1 to 311_K formed at the third flowing tube 23 may conduct a stream of the air between an inner part and outer part of the third flowing tube 23 within the receiving volume.

As seen in FIG. 4b, the third flowing tube 23 may become a double walled structure by coupling the coupling wing 235 with a coupling tab 235a to a receiving wing 234 with a receiving groove 234a. Similarly the first flowing tube 21 may become a double walled structure by coupling the coupling wing 213 to the fixing wing 214. Furthermore, the second flowing tube 22 may be a double walled structure optionally.

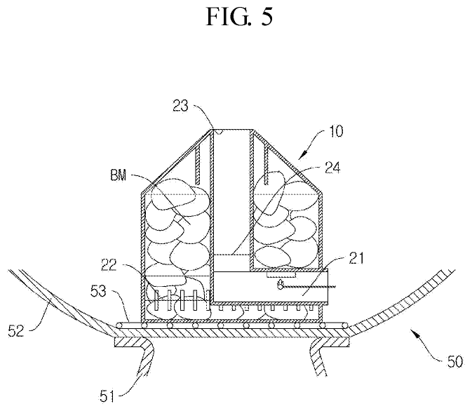

FIG. 5 shows an example using the igniting container according to an embodiment of the present invention.

Referring to FIG. 5, an apparatus 50 for roasting may comprise a charcoal fire house 52 supported by a supporter 51 and a roasting plate 53 displaced above the charcoal fire house 52. The igniting container 10 may be located a bottom surface of the charcoal fire house 52. At first, the igniting key may be separated from the container 10 to input within the third flowing tube 23 for igniting the igniting plate 24. At the same time, the outer air can be introduced within the receiving volume through the first and second flowing tube 21, 22. The first, second and third flowing tube 21, 22, 23 may be burned together with burning the igniting plate 24, and then a process for making a charcoal fire by burning the inflammable material BM. If the charcoal fire is made, the roasting plate 53 can be located at the charcoal fire house 52 to make a roasted meat on the roasting plate 53.

While the present invention has been particularly shown and described with reference to exemplary embodiments thereof, it will be understood by those skilled in the art that various changes in form and details may be made therein without departing from the spirit and scope of the present invention as defined by the appended claims.

What is claimed is:

1. A fire cube type of an igniting container, comprising:
a receiving volume formed by at least one wall, and made for an inflammable material;
a flowing exit formed at an upper part of the receiving volume;
a first and second opening formed at opposite parts of the at least one wall;
an ignition guiding module forming a plural of flowing tubes to connect the flowing exit, the first and second opening, and displaced within the receiving volume,
wherein an ignition is initiated at a position where the plural of flowing tubes intersect.

2. The fire cube type of an igniting container according to claim 1, wherein a bottom surface of the receiving volume is coupled to the at least one wall with at least one protruding tab formed at a periphery of the bottom surface.

3. The fire cube type of an igniting container according to claim 1, the plural of flowing tubes comprise a first and a second flowing tube extending in opposite direction and have different section sizes.

4. The fire cube type of an igniting container according to claim 3, wherein a passage center of the second flowing tube is located below that of the first flowing tube.
